(19) United States
(12) Patent Application Publication
(10) Pub. No.: US 2013/0158195 A1
(43) Pub. Date: Jun. 20, 2013

(54) Delustrant Composed of Polyimide Powder, Polyimide Film Incorporating The Delustrant, and Manufacture Thereof

(71) Applicants: Chung-Yi Chen, Hsinchu Hsien (TW); Sheng-Yu Huang, Hsinchu Hsien (TW); Wei-Dun Jhuang, Hsinchu Hsien (TW)

(72) Inventors: Chung-Yi Chen, Hsinchu Hsien (TW); Sheng-Yu Huang, Hsinchu Hsien (TW); Wei-Dun Jhuang, Hsinchu Hsien (TW)

(73) Assignee: Taimide Technology Incorporation, Hsinchu Hsien (TW)

(21) Appl. No.: 13/600,293

(22) Filed: Aug. 31, 2012

(30) Foreign Application Priority Data
Dec. 16, 2011 (TW) 100146877

(51) Int. Cl. C08L 79/08; C08K 3/04; B29C 41/00; C08G 73/16

(52) U.S. Cl. 524/600; 528/353; 428/402; 264/331.12

(57) ABSTRACT

A polyimide film with low gloss comprising a polyimide base polymer constituting the film, and a polyimide powder distributed in the film, the polyimide film having a 60° gloss value smaller or equal to about 50. The polyimide powder used as delustrant can have an average particle size between about 0.5 μm and about 15 μm. Embodiments described herein also include methods of preparing the polyimide film and the delustrant.

### CROSS-REFERENCE TO RELATED APPLICATION

This application claims priority to Taiwan Application No. 100146877, filed Dec. 16, 2011.

### BACKGROUND OF THE INVENTION

The present inventions relate to delustrants composed of polyimide powder, polyimide films incorporating the polyimide powder delustrant and manufacture methods thereof.

Polyimide films are widely used in electronic products. Owing to high surface flatness, the polyimide film may cause light reflection that may be uncomfortable to viewing and causes eyestrain during extensive use. This effect may be magnified in color films which can render the reflected light even more significant to the viewer.

To reduce the gloss of the polyimide film, a delustrant may be incorporated into the polyimide film to increase its surface roughness, so that incident light can be scattered. Conventional delustrants may include inorganic and organic compounds.

Examples of inorganic compounds used as a delustrant can include silicon oxide, aluminum oxide, calcium carbonate, barium sulphate, titanium dioxide and the like. However, inorganic particles have a relatively high dielectric constant, which may confer poor insulation property to the film.

Examples of organic compounds used as delustrant can include polycarbonate (PC), polystyrene (PS), polymethylmethacrylate (PMMA), polyethylene, polypropylene, polyethylene terephthalate (PET), epoxy resin and the like. However, the organic compound cannot tolerate a temperature above 250° C., which is approximately the temperature at which chemical conversion occurs in the manufacture of the polyimide film. As a result, using organic compounds in the manufacture of the polyimide film may produce defects such as cracks or apertures, or form spots of non-uniform color due to uneven melting.

Therefore, there is a need for a polyimide film with desirable properties and low gloss that addresses the aforementioned issues.

### BRIEF SUMMARY OF THE INVENTION

The present application describes a low-gloss polyimide film with a 60° gloss value smaller or equal to about 50. The polyimide film includes a polyimide base polymer, and about 5 wt % to about 10 wt % of a polyimide powder. The polyimide base polymer forms a main molecular structure of the film, which is obtained by reacting diamine with dianhydride components in substantially equal molar ratio. The polyimide powder is distributed in the film.

The present application also describes a method of preparing the polyimide film, which comprises performing condensation polymerization of monomers including a diamine and a dianhydride to obtain a solution containing polyamic acid (PAA), adding a polyimide powder into the solution containing PAA, adding a dehydrant and a catalyst into the solution containing PAA to obtain a precursor solution, coating a layer of the precursor solution on a support, and baking the coated layer to form a low-gloss polyimide film.

Some embodiments described in the present application include a delustrant composed of a polyimide powder having an average particle size between about 2 μm and about 10 μm, the polyimide powder being obtained by reacting 4,4′-oxydianiline (4,4′-ODA) with pyromellitic dianhydride (PMDA).

In addition, the present application also describes a method of preparing a polyimide powder, which comprises adding a diamine and a dianhydride with monomer in a molar ratio of about 1:0.950 to 1:0.995 into a solvent to obtain a reaction solution, where the total weight ratio of the diamine and the dianhydride is between about 2 wt % and about 20 wt % of the reaction solution, adding a dehydrant and a catalyst into the reaction solution to obtain a mixture, and heating the mixture to obtain a precipitate of polyimide.

### BRIEF DESCRIPTION OF THE DRAWINGS

FIG. 1 is a graph plotting the particle size distribution of a polyimide powder prepared according to one embodiment.

### DETAILED DESCRIPTION OF THE INVENTION

The present application describes low-gloss polyimide films that include a polyimide base polymer forming a main molecular structure of the film, and a polyimide powder distributed in the film.

The polyimide base polymer can be obtained by reacting diamine with dianhydride components, the molar ratio of the monomers of diamine and dianhydride being substantially equal to 1:1. One or more diamine component can be reacted with one or more dianhydride components to form the polyimide base polymer. Examples of diamine components can include, without limitation, 4,4′-oxydianiline (4,4′-ODA), p-phenylenediamine (p-PDA), 2,2′-bis(trifluoromethyl)benzidine (TFMB) and the like. Examples of dianhydride components can include, without limitation, pyromellitic dianhydride (PMDA), 3,3′,4,4′-biphenyltetracarboxylic dianhydride (BPDA), 2,2-bis[4-(3,4-dicarboxyphenoxy)phenyl]propane dianhydride (BPADA) and the like.

By adding polyimide powder as a delustrant into the film, uneven microstructures can be formed on the surface of the polyimide film, and/or light-scattering structures can be formed in the polyimide film. Accordingly, incident light can be effectively scattered to reduce gloss.

The polyimide powder used as a delustrant can have an average particle size or diameter between about 0.5 μm and about 15 μm. More specifically, the average particle size of the polyimide powder can be about 0.7 μm, 1 μm, 2 μm, 3 μm, 5 μm, 7 μm, 10 μm, 11 μm, 12 μm, 13 μm, or any intermediate values between these values. For example, the polyimide powder can have an average particle size between about 1 μm and about 12 μm, such as between about 2 μm and about 10 μm.

In one embodiment, the added amount of the polyimide powder can have a weight ratio between about 5 wt % and about 10 wt % of the total weight of the polyimide film. For example, the weight ratio of the polyimide powder can be about 5.5 wt %, 6 wt %, 7 wt %, 8 wt %, 9 wt %, 10 wt %, or a any intermediate values between these values.

The added amount and the average particle size of the polyimide powder can be selected according to the desired application of the film and/or the desired gloss value under an observation angle of about 60° (also called “60° gloss value”). For example, when the 60° gloss value has to be equal to about 25, the polyimide powder can be incorporated in an amount that is higher when the average particle size is smaller (such as 1 μm) than when the average particle size is greater (such as 12 μm).

In some embodiment, the polyimide film can have a 60° gloss value smaller or equal to about 50. For example, the 60° gloss value of the film can be between about 1 and about 50, such as about 1, 5, 10, 20, 25, 30, 35, 40, 45, 50, or any intermediate values between these values.

The polyimide powder can be obtained by reacting diamine with dianhydride components. One or more diamine components can be reacted with one or more dianhydride components to form the polyimide powder. Examples of diamine components can include, without limitation, 4,4′-ODA, TFMB or any combination thereof. Examples of dianhydride components can include, without limitation, PMDA, BPDA, BPADA, or any combination thereof.

The low-gloss polyimide film can be transparent, and exhibit misted appearance with low gloss. In some embodiments, the polyimide film can also be a color film, such as red, blue, black, yellow and the like. Color pigments can be incorporated into the polyimide film to produce a desired color. The amount of pigment can be about 2 wt % to about 10 wt % of the weight of the film.

The pigment can be a black pigment formed by carbon micro-particles, a chrome black pigment, a titanium black pigment and the like. Examples of color pigments can include carbon black, titanium black, bone black, cyanine black, acetylene black, lamp black, graphite, iron oxide black, iron black, aniline black, cyanine black and the like, which can be used individually or in combination.

In one embodiment, a black polyimide film with an increased shading rate can be formed by incorporating carbon black, titanium black or a combination thereof. In a variant embodiment, a carbon black pigment having an average particle size between about 0.1 μm and about 1.5 μm can also be used.

When a black polyimide film is formed by incorporating a polyimide powder delustrant with an average particle size greater than 10 μm or in an amount more than 10 wt %, it may be observed that the depth of the black color may be reduced and/or the film may whiten owing to the presence of white spots. Moreover, the black color of the film may be unstable in large-scale manufacture, resulting in films that have non-uniform color. In an attempt to alleviate the foregoing issues, an embodiment of a black polyimide film having a 60° gloss value smaller or equal to about 50 can incorporate about 80 wt % to about 93 wt % of a polyimide base polymer, about 2 wt % to about 10 wt % of a black pigment, and about 5 wt % to about 10 wt % of a polyimide powder having an average particle size between about 2 μm and about 10 μm.

The polyimide film can be obtained by condensation polymerization of monomers including a diamine and a dianhydride. The molar ratio of diamine to dianhydride is substantially equal to 1:1, for example, 0.90:1.10 or 0.98:1.02.

The diamine and dianhydride components can be first reacted in the presence of a solvent to obtain a polyamic acid solution. The solvent can be a non-protonic polar solvent with a relatively low boiling point (e.g., below about 225° C.), so that the solvent can be removed at a relatively low temperature. Suitable solvents can include, without limitation, dimethylacetamide (DMAC), N,N′-dimethyl-formamide (DMF) and the like.

A polyimide powder delustrant, a dehydrant and a catalyst then can be incorporated into the polyamic acid solution, which is agitated to obtain a homogeneous precursor solution. Examples of the dehydrant can include, without limitation, aliphatic acid anhydrides (such as acetic anhydride and propionic anhydride) and aromatic acid anhydrides (such as benzoic anhydride and phthalic anhydride), which can be used individually or in combination. In one embodiment, a preferable dehydrant can be acetic anhydride, and the amount can be between about 2 and 3 moles per equivalent of the polyamic acid.

Examples of the catalyst can include, without limitation, heterocyclic tertiary amines (such as picoline, pyridine, lutidine, quinoilne, isoquinoilne, cinnoline, phthalazine, quinazoline, imidazole, N-methyl-2-pyrrolidone, N-ethyl-2-pyrrolidone, N-methyl piperidine, N-ethyl piperidine and the like), aliphatic tertiary amines (such as triethylamine (TEA), tripropylamine, tributylamine, triethanolamine, N,N-dimethylethanolamine, triethylenediamine, and N,N-diisopropylethylamine (DIPEA)), and aromatic tertiary amines (such as dimethylaniline), which can be used individually or in combination. In one embodiment, a preferable catalyst is picoline (such as • α-picoline, • β-picoline or • γ-picoline). The polyamic acid-dehydrant-catalyst molar ratio can be about 1:2:1, i.e., about 2 moles of dehydrant and about 1 mole of catalyst are used for one mole of polyamic acid. If needed, a color pigment such as carbon black can be added in any of the aforementioned steps. The pigment can be mixed with the diamine and dianhydride components at the start of the condensation polymerization, or added after incorporation of the delustrant, the dehydrant or the catalyst.

Other additives can also be incorporated into the solution containing polyamic acid to confer desired properties to the polyimide film. For example, suitable additives can include, without limitation, processing aid, antioxidant, light stabilizer, flame retardant additive, anti-static agent, heat stabilizer, ultraviolet light absorbing agent and reinforcing agent, which can be used individually or in combination.

A layer of the precursor solution then can be coated on a glass or stainless plate support. The coated layer can be baked to form a low-gloss polyimide film, which can be subsequently peeled from the glass plate support. A suitable temperature range for baking is between about 90° C. and about 350° C. The formed polyimide film can have a thickness between about 3 μm and about 150 μm, for example between about 3 μm and about 75 μm, such as between about 5 μm and about 50 μm.

The polyimide powder delustrant can be obtained by condensation polymerization of a diamine monomer and a dianhydride monomer. In order to obtain a stable and desired average particle diameter, the molar ratio of diamine to dianhydride can be about 1:0.950 to 1:0.995.

Diamine and dianhydride (such as 4,4′-ODA and PMDA) components with the above molar ratio can be homogeneously mixed in a solvent to form a reaction solution. Suitable solvents can include DMAC, DMF and the like. The total amount of the monomers containing diamine and dianhydride can be between about 2 wt % and about 20 wt % of the total weight of the reaction solution. In one embodiment, the weight ratio of the monomers can be between about 5 wt % and about 15 wt % of the total weight of the reaction solution.

A dehydrant and a catalyst then can be incorporated into the reaction solution, which is agitated to obtain a reaction mixture. The dehydrant and the catalyst for preparing the polyimide powder can be similar to those used for manufacturing the polyimide film.

The reaction mixture can be heated to obtain a precipitate of polyimide forming the delustrant. The precipitate of polyimide then can be rinsed, filtrated and dried.

Owing to its excellent heat resistance, the polyimide powder delustrant can maintain stable properties during chemical conversion under a temperature range between 250° C. and 500° C. As a result, non-uniform color defects induced by color spots during the manufacture of the polyimide film can be prevented. Compared to inorganic delustrants, the polyimide powder delustrant can provide better color rendering, and higher insulating properties by lowering the dielectric constant of the film, which makes it particularly suitable for applications with high insulation requirements.

Examples for fabricating the polyimide powder delustrant and the low-gloss films are described hereafter.

### EXAMPLES

### Preparation of the Polyimide Powder

The particle size can determine the extinction effect of the polyimide powder applied as a delustrant. Polyimide powder prepared by conventional methods cannot be used as effective delustrant owing to a wide distribution of the particle size. Some embodiments of fabricating processes described herein can apply specific molar ratios of monomers and solid content to accurately control the average particle size of the polyimide powder.

### Example 1-1

About 570 g of DMAC can be added as solvent into a three-necked flask. Then, about 14.35 g of 4,4′-ODA and about 14.86 g of PMDA can be incorporated into the DMAC solvent and agitated to completely dissolve into the reaction solution. The molar ratio of 4,4′-ODA and PMDA can be about 1:0.950, and a total weight ratio of the monomers can be about 5 wt % of the weight of the reaction solution. About 3.17 g of 3-picoline then can be added into the reaction solution, which is continuously agitated and heated at about 170° C. for 18 hours to form a precipitate of polyimide. The precipitate can be rinsed by water and ethanol, undergo vacuum filtration, and then heated at about 160° C. in a baking oven for 1 hour to obtain the polyimide powder.

### Example 1-2

A polyimide powder can be prepared like in Example 1-1 except that the applied amounts include about 540 g of DMAC, about 28.70 g of 4,4′-ODA, about 29.72 g of PMDA, and about 6.34 g of 3-picoline. Accordingly, a total weight ratio of the monomers can be about 10 wt % of the weight of the reaction solution.

### Example 1-3

A polyimide powder can be prepared like in Example 1-1 except that the applied amounts include about 510 g of DMAC, about 43.05 g of 4,4′-ODA, about 44.58 g of PMDA, and about 9.51 g of 3-picoline. Accordingly, a total weight ratio of the monomers can be about 15 wt % of the weight of the reaction solution.

### Example 1-4

A polyimide powder can be prepared like in Example 1-1 except that the applied amounts include about 15.41 g of PMDA, and about 3.29 g of 3-picoline. Accordingly, the molar ratio of 4,4′-ODA to PMDA can be about 1:0.985, and a total weight ratio of the monomers can be about 5 wt % of the weight of the reaction solution.

### Example 1-5

A polyimide powder can be prepared like in Example 1-4 except that the applied amounts include about 540 g of DMAC, about 28.70 g of 4,4′-ODA, about 30.81 g of PMDA, and about 6.57 g of 3-picoline. Accordingly, a total weight ratio of the monomers can be about 10 wt % of the weight of the reaction solution.

### Example 1-6

A polyimide powder can be prepared like in Example 1-4 except that the applied amounts include about 510 g of DMAC, about 43.05 g of 4,4′-ODA, about 46.22 g of PMDA, and about 9.86 g of 3-picoline. Accordingly, a total weight ratio of the monomers can be about 15 wt % of the weight of the reaction solution.

### Example 1-7

A polyimide powder can be prepared like in Example 1-1 except that the applied amounts include about 15.57 g of PMDA, and about 3.32 g of 3-picoline. Accordingly, the molar ratio of 4,4′-ODA to PMDA can be about 1:0.995, and a total weight ratio of the monomers can be about 5 wt % of the weight of the reaction solution.

### Example 1-8

A polyimide powder can be prepared like in Example 1-7 except that the applied amounts include about 540 g of DMAC, about 28.70 g of 4,4′-ODA, about 31.14 g of PMDA, and about 6.64 g of 3-picoline. Accordingly, a total weight ratio of the monomers can be about 10 wt % of the weight of the reaction solution.

### Example 1-9

A polyimide powder can be prepared like in Example 1-7 except that the applied amounts include about 510 g of DMAC, about 43.05 g of 4,4′-ODA, about 46.70 g of PMDA, and about 9.96 g of 3-picoline. Accordingly, a total weight ratio of the monomers can be about 15 wt % of the weight of the reaction solution.

### Comparative Example 1-1

A polyimide powder can be prepared like in Example 1-1 except that the applied amounts include about 570 g of DMAC, about 14.35 g of 4,4′-ODA, about 14.08 g of PMDA, and about 6.01 g of 3-picoline. Accordingly, the molar ratio of 4,4′-ODA to PMDA is about 1:0.900, and a total weight ratio of the monomers can be about 5 wt % of the weight of the reaction solution.

### Comparative Example 1-2

A polyimide powder can be prepared like in Comparative Example 1-1 except that the applied amounts include about 510 g of DMAC, about 43.05 g of 4,4′-ODA, about 42.23 g of PMDA, and about 18.02 g of 3-picoline. Accordingly, a total weight ratio of the monomers can be about 15 wt % of the weight of the reaction solution.

### Comparative Example 1-3

A polyimide powder can be prepared like in Example 1-1 except that the applied amounts include about 576 g of DMAC, about 11.48 g of 4,4′-ODA, about 11.89 g of PMDA, and about 5.07 g of 3-picoline. Accordingly, the molar ratio of 4,4′-ODA to PMDA is about 1:0.950, and a total weight ratio of the monomers can be about 4 wt % of the weight of the reaction solution.

### Comparative Example 1-4

A polyimide powder can be prepared like in Comparative Example 1-3 except that the applied amounts include about 504 g of DMAC, about 45.93 g of 4,4′-ODA, about 47.56 g of PMDA, and about 20.29 g of 3-picoline. Accordingly, a total weight ratio of the monomers can be about 16 wt % of the weight of the reaction solution.

### Comparative Example 1-5

A polyimide powder can be prepared like in Example 1-1 except that the applied amounts include about 576 g of DMAC, about 11.48 g of 4,4′-ODA, about 12.45 g of PMDA, and about 5.31 g of 3-picoline. Accordingly, the molar ratio of 4,4′-ODA to PMDA is about 1:0.995, and a weight ratio of the monomers can be about 4 wt % of the weight of the reaction solution.

### Comparative Example 1-6

A polyimide powder can be prepared like in Comparative Example 1-5 except that the applied amounts include about 504 g of DMAC, about 45.93 g of 4,4′-ODA, about 49.81 g of PMDA, and about 21.25 g of 3-picoline. Accordingly, a total weight ratio of the monomers can be about 16 wt % of the weight of the reaction solution.

### Comparative Example 1-7

A polyimide powder can be prepared like in Example 1-1 except that the applied amounts include about 570 g of DMAC, about 14.35 g of 4,4′-ODA, about 15.65 g of PMDA, and about 6.67 g of 3-picoline. Accordingly, the molar ratio of 4,4′-ODA to PMDA is about 1:1, and a total weight ratio of the monomers can be about 5 wt % of the weight of the reaction solution.

### Comparative Example 1-8

A polyimide powder can be prepared like in Comparative Example 1-7 except that the applied amounts include about 510 g of DMAC, about 43.05 g of 4,4′-ODA, about 46.95 g of PMDA, and about 20.02 g of 3-picoline. Accordingly, a total weight ratio of the monomers can be about 15 wt % of the weight of the reaction solution. The reaction solution can be continuously agitated and heated at about 170° C. for 18 hours, but no precipitate of polyimide is formed. In other words, no polyimide powder can be formed.

### Testing of the Polyimide Powder

The polyimide powders obtained from the above examples and comparative examples can be tested to determine the distribution of the particle size.

A particle size analyzer (Horiba LA-950, sold by Horiba Instruments) can be used to measure the particle sizes. The polyimide powder can be dispersed in a flow carrier DMAC, and dispersed through a grinder. The particle sizes measured from the polyimide powder can be verified by SEM. The results are shown in Table 1 below.

TABLE 1
Particle Size Results

| | Solid | Molar ratio | | | Effective |
|---|---|---|---|---|---|
| | Content | (diamine:dian- | D₅₀ | D₉₀ | Particle |
| | (%) | hydride) | (μm) | (μm) | Size (%) |
| Example 1-1 | 5 | 1:0.950 | 2.7 | 5.9 | 70.6 |
| Example 1-2 | 10 | 1:0.950 | 2.8 | 6.0 | 73.1 |
| Example 1-3 | 15 | 1:0.950 | 3.0 | 6.3 | 77.9 |
| Example 1-4 | 5 | 1:0.985 | 3.4 | 6.0 | 73.8 |
| Example 1-5 | 10 | 1:0.985 | 3.7 | 6.6 | 75.5 |
| Example 1-6 | 15 | 1:0.985 | 4.2 | 7.0 | 91.6 |
| Example 1-7 | 5 | 1:0.995 | 3.3 | 6.7 | 79.1 |
| Example 1-8 | 10 | 1:0.995 | 4.5 | 6.9 | 82.5 |
| Example 1-9 | 15 | 1:0.995 | 6.5 | 9.7 | 92.5 |
| Comparative | 5 | 1:0.900 | 0.5 | 2.7 | 13.7 |
| Example 1-1 | | | | | |
| Comparative | 15 | 1:0.900 | 1.4 | 3.9 | 14.1 |
| Example 1-2 | | | | | |
| Comparative | 4 | 1:0.950 | 2.6 | 5.8 | 67.9 |
| Example 1-3 | | | | | |
| Comparative | 16 | 1:0.950 | 3.1 | 7.5 | 67.3 |
| Example 1-4 | | | | | |
| Comparative | 4 | 1:0.995 | 3.3 | 6.7 | 68.7 |
| Example 1-5 | | | | | |
| Comparative | 16 | 1:0.995 | 6.7 | 10.9 | 56.5 |
| Example 1-6 | | | | | |
| Comparative | 5 | 1:1 | 3.5 | 12.3 | 68.4 |
| Example 1-7 | | | | | |
| Comparative | 15 | 1:1 | — | — | No powder |
| Example 1-8 | | | | | formation |

In Table 1, “solid content” means the weight percentage of the monomers in the reaction solution; “D50” is the median diameter, i.e., it is the particle size for which the cumulative distribution percentage reaches 50% (there are 50% of particles with a size higher than the value D50, and 50% smaller than the value D50); “D90” is the particle size for which the cumulative distribution percentage reaches 90% (there are 90% of particles with a size higher than the value D90), which is used as a particle size index to represent larger particle of the powder; and the “effective particle size (S)” is defined as S=B/(A+B+C)×100%, wherein A is the amount percentage of particles in the polyimide powder having a size smaller than 2 μm, B is the amount percentage of particles in the polyimide powder having diameter between 2-10 μm, and C is the amount percentage of particles in the polyimide powder having a size larger than 10 μm.

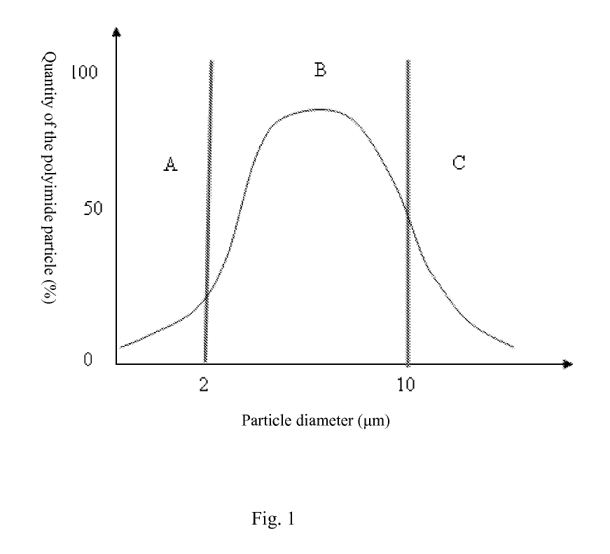

FIG. 1 is a graph plotting a distribution of particle size in the polyimide powder.

Referring to FIG. 1 and Table 1, in Examples 1-1 to 1-9 where the molar ratio of 4,4′-ODA to PMDA is between about 0.95 and about 0.995 and the monomer solid content has a weight ratio between about 5 wt % and about 15 wt % of the reaction solution, the value D50 of the polyimide powder is between about 2.7 μm and about 4.9 μm, the value D90 is between about 5.9 μm and about 7.3 μm, and the effective particle size (S) is higher than 70%.

In contrast, with Comparative Examples 1-1, 1-2, 1-7 and 1-8 where the molar ratio is lower than 0.95 or higher than 0.995 and the solid content is 5 wt % or 15 wt %, the effective particle size (S) cannot reach 70%, or even no particle can be formed. In addition, in Comparative Examples 1-3 to 1-6 where the molar ratio is within the range of 0.95-0.995 and the solid content is either lower than 5 wt % or exceeds 15 wt %, the effective particle size (S) still cannot reach 70%.

Accordingly, controlling the molar ratio of diamine to dianhydride between about 1:0.95 and about 1:0.995 and the solid content between about 5 wt % and about 15 wt % obtains an effective particle size (S) that is as high as 70% or even higher.

### Preparation of the Black Polyimide Film

Step 1. Preparation of the Polyimide Powder

About 14.35 g of 4,4′-ODA, about 14.86 g of PMDA, and about 570 g of DMAC can be mixed into a three-necked flask to obtain a reaction solution. The molar ratio of 4,4′-ODA to PMDA is about 1:0.950, and a total weight ratio of the monomers can be about 5 wt % of the reaction solution. About 3.35 g of 3-picoline then can be added into the reaction solution, which is continuously agitated and heated at a temperature of 170° C. for 18 hours to form a precipitate of polyimide. The precipitate can be rinsed by water and ethanol, undergo vacuum filtration, and heated at a temperature of 160° C. for 1 hour, and about 26.7 g of polyimide powder can be thereby obtained.

Step 2. Preparation of a Carbon Black Slurry

About 500 g of carbon black (Regal-R400, sold by CABOT Company) and about 4,000 g of DMAC can be mixed and agitated for 15 minutes. The mixture then can be processed through a grinder to obtain a carbon black slurry.

Step 3. Preparation of the Black Polyamic Acid (PAA) Solution

About 45 g of the carbon black slurry, about 833 g of a polyamic acid solution having 18 wt % of solid content and formed from polymerization of 4,4′-ODA, para-phenylenediamine (p-PDA) and PMDA with a viscosity of about 150,000 cps, and about 122 g of DMAC as solvent can be mixed homogeneously to obtain a black PAA solution having a weight of about 1,000 g with a solid content equal to about 15.49 wt %.

Step 4. Preparation of the Black Polyimide Film

### Example 3-1

About 0.37 g of the polyimide powder (particle size equal to about 2.1 μm) obtained from Step 1, about 49.83 g of the black PAA solution obtained from Step 3, and about 15.2 g of DMAC can be added into a flask and agitated for 1-2 hours to obtain a low-gloss black PAA solution. The low-gloss black PAA solution can be coated on a glass plate support and baked in an oven. The baking condition can be set at a temperature of 90° C. for 30 minutes to remove most solvent, and then 170° C.-350° C. for 4 hours to form a low-gloss black polyimide film. The film peeled from the glass plate support can contain 5 wt % of polyimide powder with an average particle size equal to about 2.1 μm.

### Example 3-2

A film is prepared like in Example 3-1 except that the solid content of the monomers 4,4′-ODA and PMDA is about 15 wt %, and the average particle size of the polyimide powder is about 5.5 μm.

### Example 3-3

A film can be prepared like in Example 3-1 except that the solid content of the monomers 4,4′-ODA and PMDA is about 15 wt %, the molar ratio of 4,4′-ODA to PMDA is about 1:0.995, and the average particle size of the polyimide powder is about 8.6 μm.

### Example 3-4

A film can be prepared like in Example 3-1 except that the added amount of polyimide powder is about 0.78 g. Accordingly, the low-gloss black polyimide film can contain about 10 wt % of the polyimide powder with an average particle size equal to about 2.1 μm.

### Example 3-5

A film can be prepared like in Example 3-2 except that the added amount of polyimide powder is about 0.78 g. The polyimide powder has an average particle size equal to about 5.5 μm.

### Example 3-6

A film can be prepared like in Example 3-3 except that the added amount of polyimide powder is about 0.78 g. The polyimide powder has an average particle size equal to about 8.6 μm.

### Comparative Example 3-1

A film can be prepared like in Example 3-1 except that the added amount of polyimide powder is about 0.008 g with a particle size of about 2.1 μm. Accordingly, the low-gloss black polyimide film contains about 1 wt % of the polyimide powder.

### Comparative Example 3-2

A film can be prepared like in Comparative Example 3-1 except that the solid content of the monomers 4,4′-ODA and PMDA is about 15 wt %, and the average particle size of the polyimide powder is about 5.5 μm.

### Comparative Example 3-3

A film can be prepared like in Comparative Example 3-1 except that the solid content of the monomers 4,4′-ODA and PMDA is about 15 wt %, the molar ratio of 4,4′-ODA to PMDA is about 1:0.995, and the average particle size of the polyimide powder is about 8.6 μm.

### Comparative Example 3-4

A film can be prepared like in Example 3-1 except that no polyimide powder is added.

### Comparative Example 3-5

A film can be prepared like in Example 3-7 except that no polyimide powder is added, and about 0.37 g of SiO₂ powder with a particle size of about 5.2 μm (sold by GRACE Company under the product designation “P405”) is used as delustrant.

### Comparative Example 3-6

A film can be prepared like in Example 3-7 except that no polyimide powder is added, and about 0.37 g of Al₂O₃ powder with a particle size of about 5.4 μm (sold by Denka Company under the product designation “ASFP-20”) is used as delustrant.

### Testing of Optical Properties of the Black Polyimide Film

The 60° gloss value and the total transparency of the black polyimide film prepared according to the aforementioned examples and comparative examples can be measured, the results of which are shown in Table 2.

TABLE 2
Optical properties of the black polyimide film

| | Delustrant | | | | |
|---|---|---|---|---|---|
| | | | Average | Black polyimide film | |
| | | | particle | | Total |
| | | Content | size | 60° gloss | transparency |
| | Type | (wt %) | (μm) | value | (%) |
| Example 3-1 | polyimide | 5 | 2.1 | 48 | 0.01 |
| | powder | | | | |
| Example 3-2 | polyimide | 5 | 5.5 | 37 | 0.01 |
| | powder | | | | |
| Example 3-3 | polyimide | 5 | 8.6 | 27 | 0.04 |
| | powder | | | | |
| Example 3-4 | polyimide | 10 | 2.1 | 19 | 0.08 |
| | powder | | | | |
| Example 3-5 | polyimide | 10 | 5.5 | 15 | 0.02 |
| | powder | | | | |
| Example 3-6 | polyimide | 10 | 8.6 | 14 | 0.11 |
| | powder | | | | |
| Comparative | polyimide | 1 | 2.1 | 129 | 0.01 |
| Example 3-1 | powder | | | | |
| Comparative | polyimide | 1 | 5.5 | 117 | 0.12 |
| Example 3-2 | powder | | | | |
| Comparative | polyimide | 1 | 8.6 | 102 | 0.01 |
| Example 3-3 | powder | | | | |
| Comparative | None | 0 | — | 125 | 0.01 |
| Example 3-4 | | | | | |
| Comparative | SiO₂ | 5 | 5.2 | 33 | 0.01 |
| Example 3-5 | | | | | |
| Comparative | Al₂O₃ | 5 | 5.4 | 77 | 0.01 |
| Example 3-6 | | | | | |

The gloss meter sold under the designation NIPPON DEMSHOKU PG-1M can be used to measure the 60° gloss value, which can be obtained as an average of three to six measures. The haze meter sold under the designation NIPPON DEMSHOKU NDH 2000 can be used to measure the total transparency, which can be obtained as an average of three to six measures.

As shown in Table 2, compared to a black polyimide film formed without addition of delustrant (e.g., Comparative Example 3-4), the low-gloss black polyimide film incorporating the polyimide powder delustrant can have a lower 60° gloss value, and can exhibit high shading rate (i.e., lower than 0.1% of the total transparency). In particular, as shown in Examples 3-1 to 3-6, the 60° gloss value can be reduced below 50 when 5 wt % or more of the polyimide powder is incorporated. The 60° gloss value can be reduced as more of the polyimide powder is added. Compared to the conventional delustrants used in Comparative Examples 3-5 and 3-6, the use of the polyimide powder as delustrant can yield equal or even better extinction effects.

When the added amount of polyimide powder is lower than 5 wt % (which is the case for Comparative Example 1-3), the 60° gloss value of the film can still be higher than 100, even when the average particle size of the polyimide powder is between 2 μm and 10 μm. Moreover, when the amount of the polyimide powder is lower than 5 wt %, the 60° gloss value of the film can also be higher than 100 even if the average particle size is larger than 10 μm (not shown in the table).

Using a polyimide powder with excessively small particle sizes (e.g., smaller than 0.5 μm) may reduce the surface roughness of the film, which may result in insufficient scattering of incident light. If a larger amount of the polyimide powder were used for obtaining the desired 60° gloss value, the dispersion of the powder particles may be reduced and/or the properties of the film may even be affected.

On the other hand, polyimide powder with an excessively large particle size may produce a coarser film surface, especially in thinner films (e.g., lower than 80 μm in thickness), which may affect the surface evenness. Moreover, the bigger particles of the polyimide powder may easily detach and contaminate following processing.

### Preparation of the Low-Gloss Polyimide Film

### Example 5-1

About 6.1 g of the polyimide powder (particle size about 5 μm) and about 160.6 g of DMAC can be mixed into a flask. About 333.3 g of a PAA solution of a solid content equal to about 18 wt % (polymerized from 4,4′-ODA, p-PDA and PMDA having a viscosity of about 150,000 cps) then can be added and continuously agitated, until a PAA solution having a total weight of 500 g with a solid content of the monomers equal to about 13.2 wt % can be obtained. About 60 g of the PAA solution then can be blade coated on a glass plate support and baked in an oven. The baking condition can include heating at a temperature of about 90° C. for 30 minutes to remove most solvent, and then at 170° C.-350° C. for 4 hours to form a low-gloss polyimide film containing about 10 wt % of the polyimide powder.

### Comparative Example 5-1

A film can be prepared like in Example 5-1 except that no polyimide powder is added, and about 10 wt % of Al₂O₃ powder with a particle size of about 5.4 μm (sold by Denka Company under the designation “ASFP-20”) is incorporated as delustrant.

### Comparative Example 5-2

A film can be prepared like in Example 5-1 except that no polyimide powder is added, and about 10 wt % of SiO₂ powder with a particle size of about 5.2 μm (sold by GRACE Company under the designation “P405”) is incorporated as delustrant.

### Comparative Example 5-3

A film can be prepared like in Example 5-1 except that no polyimide powder is added, and about 10 wt % of TiO₂ powder with a particle size of about 5 μm (sold by Sigma Aldrich Company) is incorporated as delustrant.

### Measure of the Dielectric Constant of the Polyimide Film

The ASTM D150-95 standard test can be used to measure the dielectric constant of the polyimide films fabricated according to the above examples and comparative examples. Impedance analyzer Agilent 4294A (clip type 16034G) can be used to determine the dielectric constant of each film, which can be an average of three measures. The results are shown in Table 3.

TABLE 3
Test results of dielectric constant of polyimide film with low gloss

| | Delustrant | Dielectric Constant |
|---|---|---|
| Example 5-1 | PI | 3.60 |
| Comparative Example 5-1 | Al₂O₃ | 3.88 |
| Comparative Example 5-2 | SiO₂ | 3.73 |
| Comparative Example 5-3 | TiO₂ | 5.60 |

As shown in Table 3, compared to conventional inorganic delustrants, incorporating a suitable amount of polyimide powder provides a film with a lower dielectric constant and better insulation properties, which makes it particularly suitable for applications with high insulation requirement.

The embodiments and examples described herein can fabricate polyimide powders with enhanced extinction effects, high insulation and good heat resistance. The polyimide powder may be used in association with a carbon black pigment (e.g., in an amount of about 2-10 wt %) to fabricate a black polyimide film with high shading property, low gloss, enhanced insulation and heat resistance.

Examples of applications for the polyimide film can include, without limitation, flexible printed boards (FPC), rigid printed boards, flexible-rigid printed board, LCDs, LEDs, photovoltaic cells, TFT-LCDs, OLEDs, portable communication devices, digital cameras, laptops, e-books, tablet PCs and the like.

Realizations of the films, polyimide powder delustrants and related fabrication methods have been described in the context of particular embodiments. These embodiments are meant to be illustrative and not limiting. Many variations, modifications, additions, and improvements are possible. These and other variations, modifications, additions, and improvements may fall within the scope of the inventions as defined in the claims that follow.

We claim:

1. A polyimide film comprising:
a polyimide base polymer forming a main molecular structure of the film, the polyimide base polymer being obtained by reacting diamine with dianhydride components in substantially equal molar ratio; and
about 5 wt % to about 10 wt % of a polyimide powder distributed in the film;
wherein the film has a 60° gloss value less than or equal to about 50.

2. The polyimide film according to claim 1, further comprising a color pigment.

3. The polyimide film according to claim 2, wherein the color pigment has a weight ratio between about 2 wt % and about 10 wt % of the weight of the film.

4. The polyimide film according to claim 2, wherein the color pigment is carbon black.

5. The polyimide film according to claim 1, wherein the polyimide powder is obtained by reacting 4,4′-oxydianiline (4,4′-ODA) with pyromellitic dianhydride (PMDA).

6. The polyimide film according to claim 5, wherein 4,4′-ODA and PMDA have a molar ratio of about 1:0.950 to 1:0.995.

7. The polyimide film according to claim 1, wherein the polyimide powder has an average particle size between about 2 μm and about 10 μm.

8. A method for preparing a polyimide film, comprising:
performing condensation polymerization of monomers including a diamine and a dianhydride to obtain a solution containing polyamic acid;
adding a polyimide powder into the solution;
adding a dehydrant and a catalyst into the solution to obtain a precursor solution;
coating a layer of the precursor solution on a support; and
baking the layer coated on the support to form a polyimide film;
wherein the polyimide powder is distributed in the polyimide film, and the film has a 60° gloss value less than or equal to about 50.

9. The method according to claim 8, wherein the polyimide powder is obtained by reacting 4,4′-oxydianiline (4,4′-ODA) with pyromellitic dianhydride (PMDA).

10. The method according to claim 8, wherein the polyimide powder has an average particle size between about 2 μm and about 10 μm.

11. The method according to claim 8, wherein the polyimide powder has a weight ratio between about 5 wt % and about 10 wt % of the weight of the film.

12. The method according to claim 8, further comprising adding a color pigment into the solution containing the polyamic acid before coating a layer of the precursor solution on a support.

13. A method of preparing a polyimide powder, comprising:
adding a diamine and a dianhydride at a molar ratio of about 1:0.950 to 1:0.995 into a solvent to obtain a reaction solution, wherein the sum of the diamine and the dianhydride has a weight ratio between about 2 wt % and about 20 wt % of the total weight of the reaction solution;
adding a dehydrant and a catalyst into the reaction solution to obtain a mixture; and
heating the mixture to obtain a precipitate of polyimide.

14. The method according to claim 13, wherein the diamine is 4,4′-oxydianiline (4,4′-ODA) and the dianhydride is pyromellitic dianhydride (PMDA).

15. The method according to claim 13, wherein the total amount of the diamine and the dianhydride is between about 5 wt % and about 15 wt % of the total weight of the reaction solution.

16. The method according to claim 13, further comprising rinsing, filtrating and drying the precipitate of polyimide.

17. A polyimide powder having an average particle size between about 2 μm and about 10 μm, the polyimide powder being obtained by reacting 4,4′-oxydianiline (4,4′-ODA) with pyromellitic dianhydride (PMDA).
